(19) United States
(12) Patent Application Publication
(10) Pub. No.: US 2019/0128297 A1
(43) Pub. Date: May 2, 2019

(54) CARDBOARD FASTENER SYSTEM

(71) Applicant: Abraham Lamark, Des Moines, IA (US)

(72) Inventor: Abraham Lamark, Des Moines, IA (US)

(21) Appl. No.: 16/169,805

(22) Filed: Oct. 24, 2018

Related U.S. Application Data
(60) Provisional application No. 62/576,475, filed on Oct. 24, 2017.

(51) Int. Cl. F16B 5/02; F16B 25/10

(52) U.S. Cl. CPC F16B 5/02; F16B 25/103

(57) ABSTRACT

A system for joining together pieces of cardboard is well-suited for use by children as a toy, or for more useful purposes such as joining cardboard to make useful structures such as furniture. The system includes various fasteners, connectors and supports that can be used to join pieces of cardboard without the need for tools such as drills, screwdrivers, wrenches, hammers, or the like. The system permits great flexibility in joining cardboard together such that it might be used to create sculptures or whimsical structures of a user's imagination, recreational structures like play forts or play houses, or more useful items like furniture.

### CROSS-REFERENCE

This application is a non-provisional and claims priority from U.S. Provisional Patent Application Ser. No. 62/576,475, filed Oct. 24, 2017, which is hereby incorporated by reference in its entirety.

### FIELD OF THE INVENTION

The invention relates generally to mechanisms and systems for joining together pieces of cardboard.

### BACKGROUND OF THE INVENTION

Cardboard is a common material used in packaging for consumer goods and other uses. Vast amounts of cardboard are thrown away. There is always a use for economical construction materials. Repurposing some of the cardboard that is thrown away as construction material would be beneficial.

Children's toys are popular and important, but can be expensive. Furthermore, they can be limited in terms of creativity that they permit. There is always a need for improved and new toys that are economical and teach creativity and dexterity.

### SUMMARY OF THE INVENTION

The present invention is directed to a system for joining together pieces of cardboard. The system is well-suited for use by children as a toy, or for more useful purposes such as joining cardboard to make useful structures such as furniture. The system includes various fasteners, connectors and supports that can be used to join pieces of cardboard without the need for tools such as drills, screwdrivers, wrenches, hammers, or the like. The system permits great flexibility in joining cardboard together such that it might be used to create sculptures or whimsical structures of a user's imagination, recreational structures like play forts or play houses, or more useful items like furniture. According to one embodiment, the present invention is directed to a cardboard fastening system that can be used to fasten pieces of cardboard in a variety of configurations. The fastening system could include a variety of fastener mechanisms including a plurality of fastener pins, wherein each of the pins has a head with a top side and an underside, a threaded member extending from a center of the underside of the head and a plurality of cardboard-engagement projections extending from the underside. The system may also include a plurality of fastener bolts and a plurality of corresponding fastener nuts, wherein each of the faster bolts has an upper portion adapted to facilitate a user to apply a torque to the bolt by hand. The system may further include a plurality of starter nuts and a male threaded rod; wherein each of the starter nuts includes a female threaded portion adapted to receive a portion of the male threaded rod, and wherein the male threaded rod is adapted to be cut to desired lengths such that the male threaded member and plurality of starter nuts can be combined to create a plurality of threaded connectors. The system may also include a plurality of angle supports adapted to connect two pieces of cardboard to form an angle, each of the angle supports comprising two plates joined at an angle, each of the plates including an angle plate opening for receiving one of the fastener pins, fastener bolts or threaded connectors. Additionally, the system may have a plurality of flat connectors adapted to connect two pieces of cardboard in a generally planar relationship, each of the flat connectors having at least one flat plate with a plurality of flat plate openings for receiving one of the fastener pins, fastener bolts or threaded connectors. The system could also include a plurality of flex connectors adapted to connect two pieces of cardboard such that the two pieces can flex relative to each other, wherein each of the flex connectors has a pair of flat rigid members attached by a flexible joint, each of the rigid members including a plurality of openings for receiving one of the fastener pins, fastener bolts or threaded connectors.

These and/or other objects, features, and advantages of the invention will be apparent to those skilled in the art. The invention is not to be limited to or by these objects, features and advantages. No single embodiment need provide each and every object, feature, or advantage.

### BRIEF DESCRIPTION OF THE DRAWINGS

FIG. 1 is an isometric view of a flat connector according to one embodiment of the present invention.

FIG. 2 is an isometric view of a smaller connector according to one embodiment of the present invention.

FIG. 3 shows an angle connector according to one embodiment of the present invention.

FIG. 4 is an isometric view of a connector used to connect cardboard pieces in a stacked angled relation to each other.

FIG. 5A is an isometric view of a domed threaded connector according to one embodiment of the present invention.

FIG. 5B is a front elevation view of the domed threaded connector of FIG. 5A.

FIG. 6 is an isometric view of a smaller domed threaded connector according to one embodiment of the present invention.

FIG. 7A is a front elevation view of a wing bolt according to one embodiment of the present invention.

FIG. 7B is an isometric view of the wing bolt of FIG. 7B.

FIG. 8A is a front elevation view of a smaller wing bolt according to one embodiment of the present invention.

FIG. 8B is an is an isometric view of the smaller wing bolt of FIG. 8A.

FIGS. 9A and 9B are isometric views of a wing nut according to one embodiment of the present invention.

FIGS. 10A and 10B are isometric views of a smaller wing nut according to one embodiment of the present invention.

FIG. 11 is an isometric view of a threaded stock according to one embodiment of the present invention.

FIG. 12A is an isometric view of a bolt base according to one embodiment of the present invention.

FIG. 12B is a cross-sectional elevation view of the bolt base of FIG. 12B.

FIG. 13A is a top plan view flat cardboard combination joined with flat connectors according to one embodiment of the present invention.

FIG. 13B is a left-side elevation view of the flat cardboard combination of FIG. 13A.

FIG. 14 is an elevation view of a corner cardboard combination joined with an angle connector according to one embodiment of the present invention.

FIG. 15 is an elevation view of a 3-ply cardboard combination joined with domed connectors and wing nuts according to one embodiment of the present invention.

### DETAILED DESCRIPTION

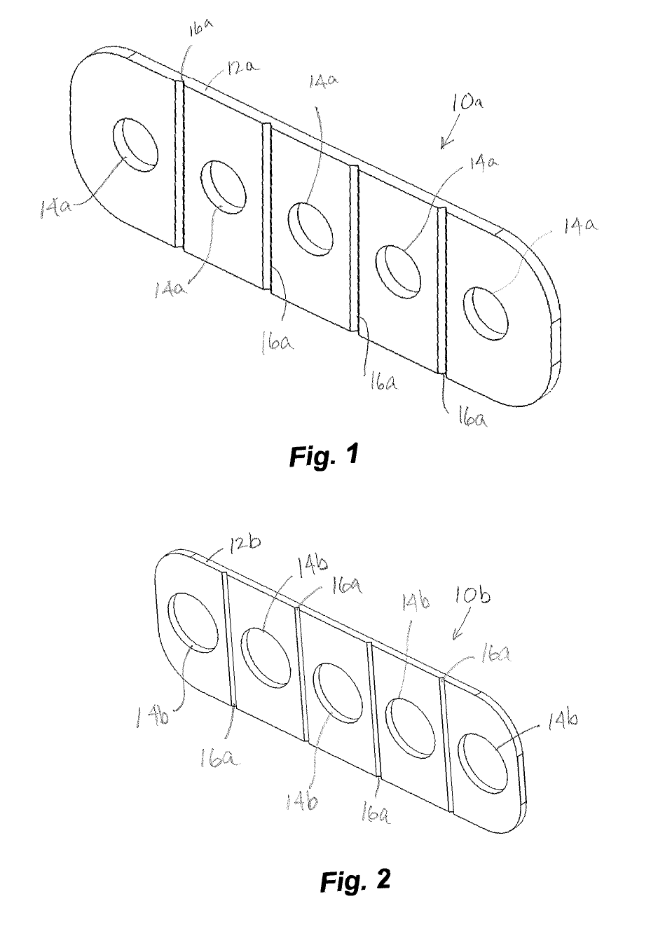

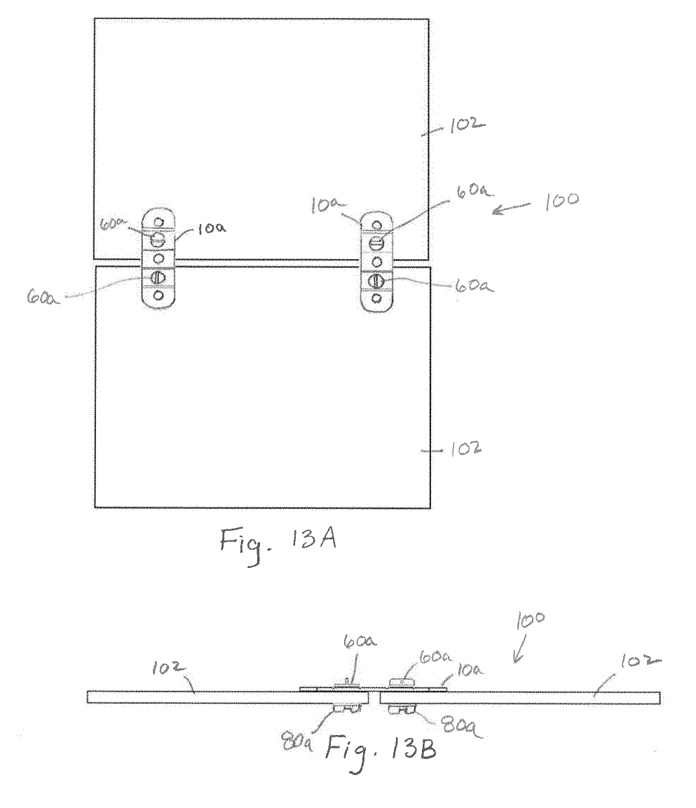

FIG. 1 shows a flat connector 10a for connecting two pieces of cardboard in a planar relation to each other (see FIGS. 13A & B). It includes several holes 14a. Each of the holes 14a is provided in its own section divided by grooves 16a. The plurality of holes 14a permits a user to connect pieces of cardboard at various distances from each other. Alternatively, more than one threaded connector (e.g., 40a) can be used in each piece of cardboard to more securely attach the connector 10a. The grooves 16a are thinned areas that permit some flexing or angling of the connector to increase the ways in which it can be used. The flat connector 10a can be formed from relatively rigid plastic, can be used as a flexible joint if made of more flexible material such as rubber. FIG. 2 shows a flat connector 10b that is similar and has like features to fastener 10a, except the sections and overall length of connector 10b is smaller.

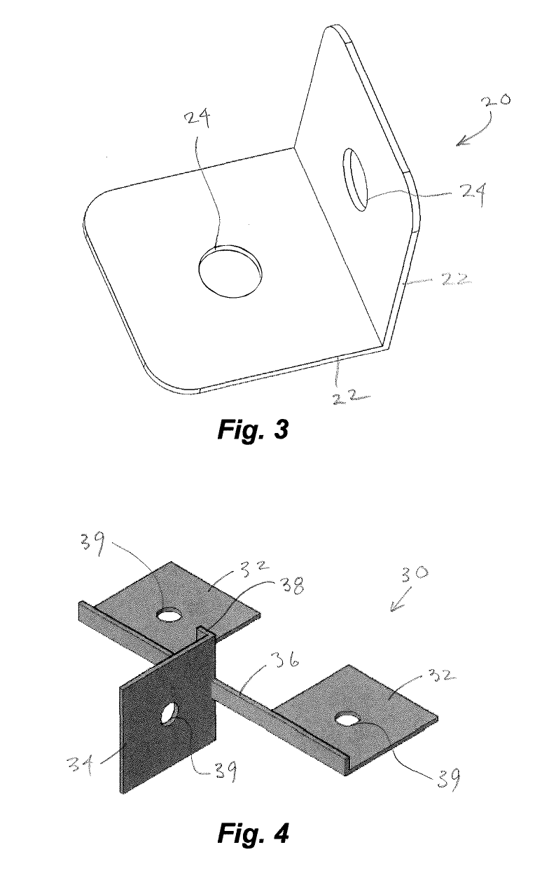

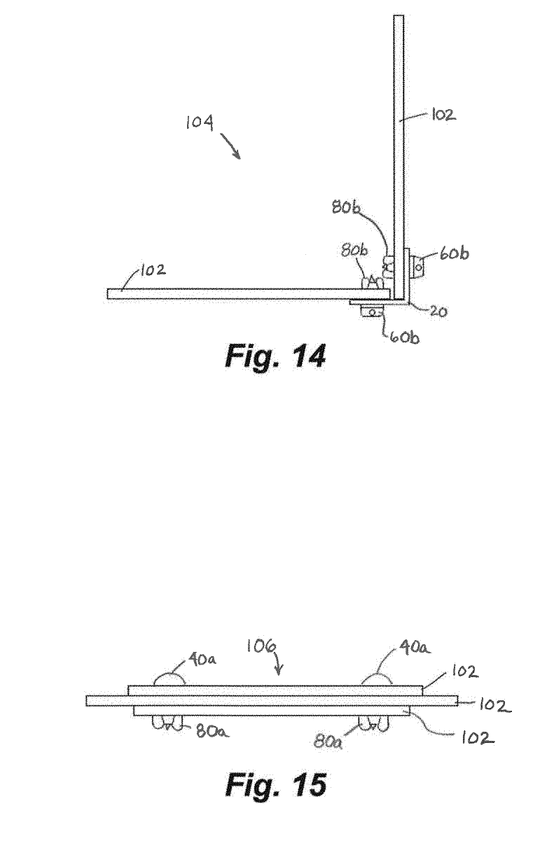

FIG. 3 shows an angle support 20 adapted to connect two pieces of cardboard to form an angle. The angle support 20 comprises two plates 22 joined at an angle, each of the plates 22 includes an angle plate opening 24 for receiving one of the fastener pins 40a, 40b, wing bolts 60a, 60b, or other connector. The angle supports 20 are used to join two pieces of cardboard at an angle to each other (see FIG. 14). In the embodiment shown, the plates 22 are connected to each other at a right angle and are used to join pieces of cardboard together at a right angle. Alternatively, the plates 22 could be joined at any angle to join cardboard at various angles. Cardboard attaches to the angle support by extending a threaded connector through the hole in the plate. While the embodiments shown include only one hole in each plate, it is contemplated that two or more holes may be included in each plate to permit even more secure attachment of the cardboard to the angle support 20. FIG. 4 shows a connector 30 for connecting two pieces of cardboard in a T-relation to each other. The connector 30 of FIG. 4 includes two square plates 32 connected by a first flange 36 that is generally perpendicular to the plates 32. A second flange 38 is co-planar and transverse to the first flange 36. A third square plate 34 extends from the second flange 38 at a generally right angle relative to the first two plates 32. The flanges 36 and 38 serve as guides that align and help support cardboard that is attached to the plates 32 and 34 via connectors through holes 39. The cardboard pieces can thus be oriented edge-to-edge at a right angle relative to each other.

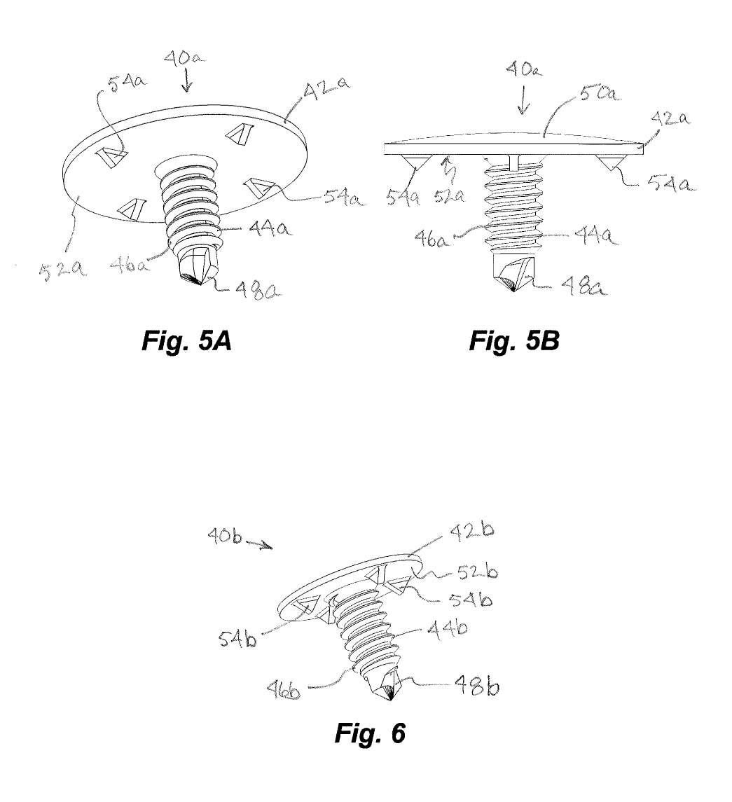

FIGS. 5A and 5B show fastener pin 40a, each of the pins 40a has a head 42a with a domed top side 50a and an underside 52a. A threaded member 44a having threads 46a extends from a center of the underside 52a of the head 42a and a plurality of cardboard-engagement cleats 54a extending from the underside. The fastener pin 40a includes a self-tapping end 48a such that no pilot hole needs to be formed in the cardboard. However, the pin 40a may be used to join pieces where one or more of the pieces has an alignment or pilot hole. The pins 40a may be made from thermoplastic or nylon, or other suitable materials. The pins 40a can be used to join two or more pieces of cardboard without the need for additional hardware such as nuts. Alternatively, the pins 40a may be used with additional hardware such as nuts, supports, hinges, and connectors show herein. The cardboard-engaging cleats 54a act to lock the pin 40a in place when screwed tight against a piece of cardboard. The pins 40a are shown with a rounded smooth head 42a with domed top 50a to present a smooth outer surface when in use. However, it is contemplated that projections may be used on the head to facilitate hand tightening of the pins. Alternatively, a slot or other feature may be included in the head to receive a screwdriver, hex key (e.g., Allen wrench) or the like. FIG. 6 shows a fastener pin 40b that is similar and has like features to fastener pin 40a, except the head 42b is smaller.

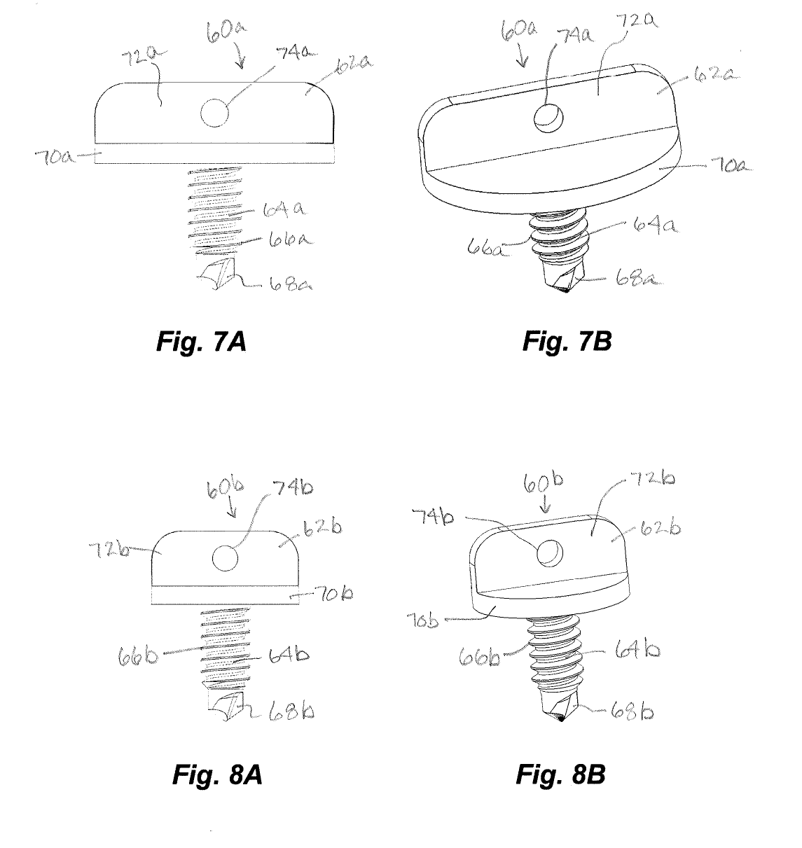

FIGS. 7A and 7B show a wing bolt 60a. The wing bolt 60a has a head 62a and a shaft 64a extending from and under side of the head 62a. The shaft 64a has threads 66a used for engaging a nut and to engage cardboard. The shaft 64a also includes a self-tapping end portion 68a. The head 62a includes a lower cap 70a that acts as a washer and an upwardly extending handle 72a. The handle 72a provides a convenient structure for a user to apply torque by hand without the use of any tools to screw the bolt 60a into cardboard and/or a nut. A hole 74a is provided through the handle 72a. This hole 74a is useful for permitting the wing bolt 60a to be connected to other structures, for example other wing bolts 60a, by string or fishing line, or the like, to make more complicated structures with swinging joints and suspended pieces. FIGS. 8A and 8B show a wing bolt 60b that is similar to wing bolt 60a, but is smaller.

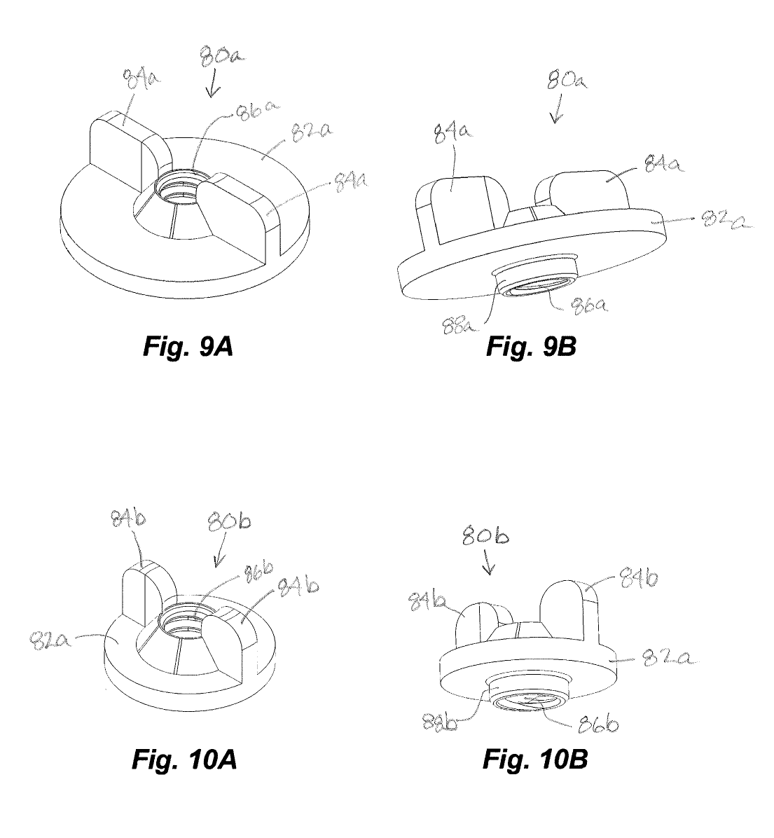

FIGS. 9A and 9B show a wing nut 80a that is adapted for mating connection with wing bolt 60a or fastener pin 40a. The nut 80a includes a lower portion 82a that acts as a washer. Wing handles 84a extend upwardly from the lower portion 82a and serve as handles to aid in applying or resisting torque on nut 80a when mating with a bolt 60a or pin 40a. A threaded passage 86a passes through the center of the lower portion 82a to provide a mating structure for the bolt 60a or pin 40a. A collar 88a extends from the lower surface of the lower portion 82a. An inner surface of the collar 88a forms part of the threaded passage 86a. The collar 88a is intended to friction fit with holes in the cardboard to more securely fix and set the nut 80a in place. FIGS. 10A and 10B show a smaller wingnut 80b that is similar in features to wing nut 80a.

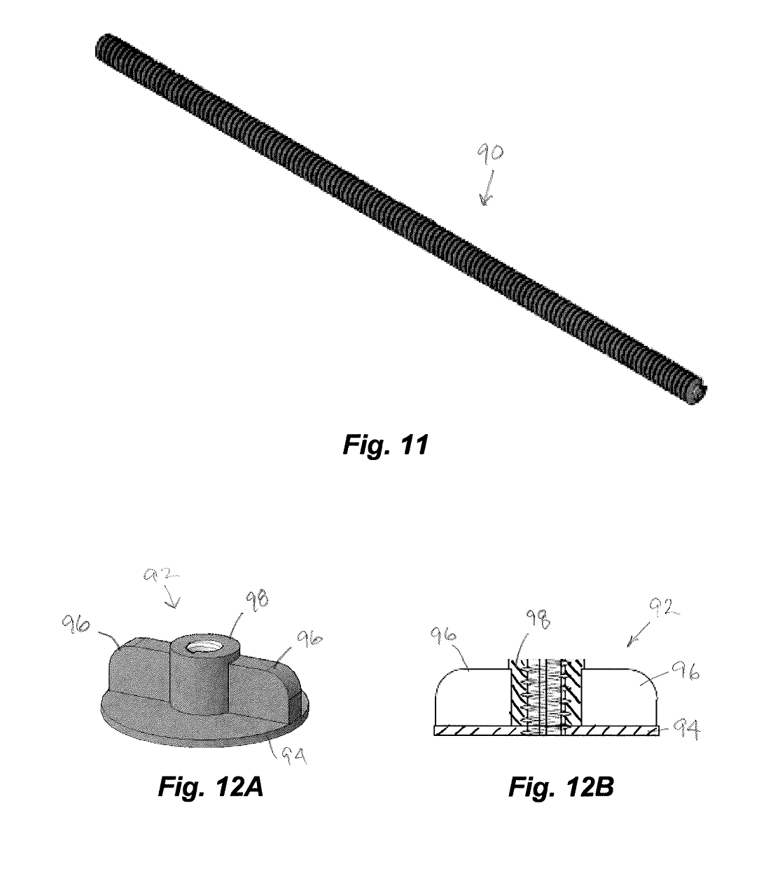

FIGS. 12A and 12B show a starter nut 92 that can be used to make fastener bolts when combined with a length of the all thread 90 shown in FIG. 11. This permits users the flexibility to make fasteners of any desired length by breaking of or cutting the all-thread 90 to a desired length. The all-thread length screws into a pre-threaded opening 98 in the starter nut to combine to form a fastener. The all-thread may be made of sufficient length to join several pieces of cardboard together to create a composite piece that has several layers and greater structural strength.

In use, the fasteners, connectors, and supports can be used to join pieces of cardboard together in a wide variety of configurations. FIGS. 13A&B, 14, and 15 show cardboard structures 100, 104, and 106 created using the fasteners, connectors, and nuts described above to connect pieces of cardboard 102 in various configurations. In many embodiments there is no need for the use of additional tools such as screwdrivers, drills, hammers, or the like. The system permits great flexibility in joining cardboard together to create sculptures or whimsical structures of a user's imagination, recreational structures like play forts or play houses, or more useful items like furniture. In particular, the multi-ply structure 106 of FIG. 15 can be used as building components for strong durable structures.

Thus, various configurations of systems have been shown and described. It should be appreciated that the system shown and described are for exemplary purposes. It is to be contemplated that numerous variations, changes, and otherwise, which are obvious to those skilled in the art are to be considered part of the present invention.

I claim:

1. A cardboard fastening system comprising:
a plurality of fastener pins, each of the pins having a head with a top side and an underside, a threaded member extending from a center of the underside of the head and a plurality of cardboard-engagement projections extending from the underside;
a plurality of fastener bolts and a plurality of corresponding fastener nuts, wherein each of the faster bolts has an upper portion adapted to facilitate a user to apply a torque to the bolt by hand;
a plurality of starter nuts and a male threaded rod; wherein each of the starter nuts includes a female threaded portion adapted to receive a portion of the male threaded rod, and wherein the male threaded rod is adapted to be cut to desired lengths such that the male threaded member and plurality of starter nuts can be combined to create a plurality of threaded connectors;
a plurality of corner supports adapted to connect three pieces of cardboard to form a corner, each of the corner supports comprising three orthogonal plates, wherein each of the orthogonal plates includes an opening for receiving one of the fastener pins, fastener bolts or threaded connectors;
a plurality of angle supports adapted to connect two pieces of cardboard to form an angle, each of the angle supports comprising two plates joined at an angle, each of the plates including an angle plate opening for receiving one of the fastener pins, fastener bolts or threaded connectors;
a plurality of flat connectors adapted to connect two pieces of cardboard in a generally planar relationship, each of the flat connectors comprising at least one flat plate having a plurality of flat plate openings for receiving one of the fastener pins, fastener bolts or threaded connectors; and
a plurality of flex connectors adapted to connect two pieces of cardboard such that the two pieces can flex relative to each other, each of the flex connectors comprising a pair of flat rigid members attached by a flexible joint, each of the rigid members including a plurality of openings for receiving one of the fastener pins, fastener bolts or threaded connectors.
